(19) United States
(12) Patent Application Publication
(10) Pub. No.: US 2024/0107944 A1
(43) Pub. Date: Apr. 4, 2024

(54) AGRICULTURAL HARVESTING MACHINE

(71) Applicant: CLAAS Selbstfahrende Erntemaschinen GmbH, Harsewinkel (DE)

(72) Inventors: Waldemar Thiesmann, Osnabrück (DE); Christoph Bussmann, Harsewinkel (DE); Christian Cord-Kruse, Warendorf (DE); Dennis Neitemeier, Lippetal (DE); Andreas Wielenberg, Herford (DE); Christian Füchtling, Rinkerode (DE); Bastian Bormann, Gütersloh (DE); Andreas Wilken, Bissendorf (DE); Maik Heufekes, Münster (DE); Joachim Baumgarten, Beelen (DE)

(73) Assignee: CLAAS Selbstfahrende Erntemaschinen GmbH, Harsewinkel (DE)

(21) Appl. No.: 18/374,820

(22) Filed: Sep. 29, 2023

(30) Foreign Application Priority Data
Sep. 29, 2022 (DE) 10 2022 125 094.6

(51) Int. Cl. A01D 41/14

(52) U.S. Cl. CPC A01D 41/141

(57) ABSTRACT

An agricultural harvesting machine having a cutting unit for cutting harvested material and a driver assistance system is disclosed. The driver assistance system includes a memory in which control strategies for the operation of the cutting unit are stored and a computing device for controlling a cutting angle of the cutting unit in accordance with the control strategies. The computing device is configured to link first and second control strategy to one another via a weighting variable, with the weighting variable being adjustable by a driver. The driver assistance system uses at least one of the control strategies and sensed forefield information to automatically determine the cutting angle of the cutting unit and to automatically control the cutting unit based on the determined cutting angle.

### CROSS REFERENCE TO RELATED APPLICATION

This application claims priority under 35 U.S.C. § 119 to German Patent Application No. DE 10 2022 125 094.6 filed Sep. 29, 2022, the entire disclosure of which is hereby incorporated by reference herein.

### TECHNICAL FIELD

The present invention relates to an agricultural harvesting machine (such as a combine harvester or a forage harvester) having a cutting unit that may be moved over an agricultural area to cut or mow a crop thereon.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

In agricultural harvesting machines (interchangeably termed harvesting machines), the cutting unit may be arranged or positioned along the front edge of a harvesting header that is mounted at the front of the agricultural harvesting machine and may be movable relative to the agricultural harvesting machine in several degrees of freedom in order to: (i) avoid, despite ground unevenness, ground contact that is detrimental to the ground structure and to the cutting unit; and (ii) minimize losses of harvested material that result, inter alia, when, for example, ears of corn lying below the cutting unit are not collected, or when cut stalks fall to the ground in front of the cutting unit, and the cutting unit then moves over them without collecting them.

U.S. Pat. No. 6,826,894, incorporated by reference herein in its entirety, discloses monitoring the distance of the harvesting header from the ground with the aid of sensing bands or brackets attached to the underside of a harvesting header in order to be able to continuously adjust the distance to a target value.

U.S. Pat. No. 6,826,894 further discloses using a second sensing band or bracket offset in the direction of travel, thereby making it possible to detect a trend of the distance from the ground.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 shows a schematic side view of a combine harvester;

FIGS. 2a-e show details of the combine harvester; and

FIG. 3 shows a block diagram of a combine harvester driver assistance system.

### DETAILED DESCRIPTION

Using sensing bands or brackets attached to the underside of a harvesting header enables continuous adjustment of the distance to a target value. However, a fundamental problem is that the sensing bands or brackets may only detect the distance to a point on the ground when the cutting unit has already passed it.

Further, even though using the second sensing band or bracket makes it possible to detect a trend of the distance from the ground, it is still nearly impossible to predict the course of the ground surface in front of the cutting edge. Controlling the position of the harvesting header in such a way that ground contact is avoided as much as possible, while performing one or more tasks (e.g., collecting as much of the crop as possible, optimizing one or more processes, such as optimizing energy consumption of the machine, optimizing cleaning losses, etc.) is a complex task. Therefore, there is no uniform approach to solve it. Instead, various control strategies have been developed for different requirements in each case, of which an operator of the agricultural harvesting machine may select the one best suited to his/her requirements in each case. See U.S. Pat. No. 9,807,926, incorporated by reference herein in its entirety.

Each of these control strategies may optimize a specific operating parameter of the machine such as any one, any combination, or all of: cut head losses; spraying grain losses; fuel consumption; or the like. However, the operator is faced with the problem that the particular operating parameter optimized in a given control strategy is generally not the only one relevant to him or her. It may be desirable to select a high target value for the height above ground to prevent ground contact with a high degree of certainty during operation; however, it may be uneconomical if the selected height is associated with excessive losses of harvested material. Conversely, a control strategy aimed at recovering as much of the harvested material as possible may also be unsatisfactory if impurities enter the harvested material from ground contact by the cutting unit that impair or reduce the crops ultimate market value. If the driver therefore does not know how to decide between two possible control strategies, it is highly likely that he/she will not make any selection of the control parameter, and the agricultural harvesting machine will be operated with settings that are not ideally adapted to the current operating conditions.

Thus, in one or some embodiments, a harvesting machine is disclosed that makes it easier for the driver to adapt settings to the current operating conditions.

This may be achieved using an agricultural harvesting machine with a cutting unit configured to cut harvested material and a driver assistance system. The driver assistance system may comprise a memory in which control strategies for the operation of the cutting unit are saved, and at least one processor of a computing device that is configured to control a cutting angle of the cutting unit in accordance with the control strategies saved in the memory. Further, at least one of the control strategies determines the cutting angle as a function of generated forefield information. This may make it possible to adapt the cutting angle directly to the conditions found in the forefield in front of the machine by configuring the computing device to link at least one first and one second control strategy to one another via a weighting variable (with the weighting variable being adjustable or modifiable by a driver). This may relieve the driver of the need to choose between two settings that are perceived as not fully suitable for the current operating conditions (and may likely not actually be ideally suitable), instead allowing the driver to make a compromise that may be expected to be better adapted to the current operating conditions than the original control strategies. Of the first and second control strategies, either one or both may be the control strategy discussed above that determines the cutting angle based on the forefield information.

The linking of the control strategies may comprise (or consist of) establishing or determining a first value of the cutting angle according to the first control strategy, establishing or determining a second value of the cutting angle according to the second control strategy, and determining a target cutting angle for the cutting unit using a calculation rule as a function of the first and second values of the cutting angle (e.g., the at least one processor controls the cutting angle of the cutting unit to be at the target cutting angle). The weighting variable may determine the influence of the first and second value on the result of the calculation rule. In particular, the calculation rule may be an average weighted with the weighting variable.

It is also contemplated that the linking comprises (or consists of) establishing or determining a first extreme value of the cutting angle permissible for being set in the cutting unit according to the first control strategy, establishing or determining a second value of the cutting angle permissible for being set in the cutting unit according to the second control strategy, and establishing or determining the cutting angle actually set in the cutting unit using a calculation rule as a function of the first and second extreme values of the cutting angle. The weighting variable may determine the influence of (e.g., how much contribution from) the first and second values on the result of the calculation rule. In particular, the calculation rule may be an average weighted with the weighting variable.

In this case, if an algorithm used to calculate the preliminary cutting angle is identical for the first and second control strategy, according to this alternative, the angles actually set in the cutting unit may be identical as long as they are within the limits set by the first and second extreme value, and differ only when a limit value is reached for one of the control strategies.

The angle between the horizontal (or a plane parallel to the ground being traveled on) and a reference plane of the cutting unit, e.g. a cutting plane in which blades of the cutting unit move, may be called the cutting angle of the cutting unit. A high cutting angle (corresponding to a sharp rise in the cutting plane in the direction of travel of the harvesting machine) may reduce harvested material losses by enabling cutting close (or closer) to the ground and accordingly complete (or better complete) collection of the harvested material. However, increasing the cutting angle may increase the risk of ground contact. Therefore, in one or some embodiments, in the instance in which the set cutting angle is a weighted average of the first and second cutting angles, the first value of the cutting angle may be smaller than the second.

Accordingly, if the cutting angle actually set in the cutting unit is restricted using a weighted average of the first and second extreme value, the first extreme value may be smaller than the second.

For setting the weighting variable, a smoothly or multistep adjustable controller, such as a slider, may be provided. The slider is one example of a user input device, which may comprise a mechanical device (such as the user physically moving the slider) and/or an electrical device (such as the slider being projected onto a touchscreen with the user providing touch-input on the touchscreen in order to provide the user setting).

In one or some embodiments, the agricultural harvesting machine includes a sensor for acquiring and/or updating the forefield information in real time.

In particular, the forefield information may include topographic information describing the forefield in front of the cutting unit of the agricultural harvester. Such topographic information may also be obtained from saved maps; however, this may not allow the consideration of short-term changes in the ground contour such as caused by animal activity (e.g., burrows, wallows, etc.), or by previous tillage such as a lane pressed into softened ground. Such changes should, however, be taken into account since fluctuations of the harvesting vehicle caused by driving over them may lead to ground contact of the cutting unit and accordingly to damage of the cutting unit, or to picking up soil material in the flow of harvested material.

In one or some embodiments, a radar sensor or a laser scanner may be suitable as a sensor for detecting this type of forefield information from a distance.

The control strategy may increase the cutting angle if the forefield information indicates a convex curvature of the ground, e.g., when the working machine makes a forward pitching movement as soon as its front wheels reach the curvature, causing the cutting unit to drop. Thus, the computing unit may be configured to detect, based on analysis of the forefield information, whether there is a convex curvature of the ground, and responsive to the determination, cause the cutting unit to drop. As a result of the then increased inclination of the cutting unit, contact with the ground, especially in the rear part of the cutting unit, may be avoided and still ensure a cut close to the ground. Conversely, the inclination and the cutting angle may decrease if the forefield information indicates a concave curvature of the ground. By thereby raising the leading edge of the cutting unit, the risk of ground contact is reduced.

The control strategy may also be designed to control the height of the cutting unit as a whole, regardless of any change in the cutting angle.

If the control strategy recognizes that the cutting unit should be lowered, for example to keep the cutting height constant while driving through a depression to avoid obstacles on the ground, then it may be appropriate for the control strategy to set the cutting angle higher during a downward movement of the cutting unit; since the height adjustment and cutting angle control interact in this way, the height of a cutting edge of the cutting unit may track the ground contour faster than if only one of the two parameters is adjusted. Accordingly, it may be provided that the control strategy sets the cutting angle lower during an upward movement than when the height of the cutting unit remains constant.

If the computing device predicts a forward pitching motion by the agricultural harvesting machine based on the topographic information, for example if a ground depression has been detected into which a front wheel of the harvester is about to enter, the risk of ground contact may also be mitigated in that the control strategy may reduce the cutting angle. In this regard, the computing device may analyze the topographic information to predict whether there is a forward pitching movement. Responsive to predicting the forward pitching movement, the computing device may send one or more commands in order to reduce the cutting angle.

Pitching movements may also lead to problems when transferring from the harvester to an accompanying vehicle since a transfer chute may follow these pitching movements with a large radius and, as a result, the point of impact of the harvested material in the accompanying vehicle may vary greatly, or the harvested material may even miss the accompanying vehicle. To counter this, the computing unit may be configured to correct the position of the transfer chute against the pitching movement if the computing unit predicts a pitching movement of the agricultural harvesting machine based on the topographical information.

The forefield information may further include information about a plant stand in the forefield, such as one or more properties of the plant stand in the forefield (e.g., density and/or height of the plant stand). For example, if the forefield information indicates that the agricultural harvesting machine is approaching an area with lying plants, it may be necessary to increase the cutting angle to allow cutting at a lesser distance from the ground and accordingly limit harvest losses due to fruit lying below the cutting height. In this regard, the computing device is configured to analyze sensor data regarding the forefield in order to identify whether the forefield has lying plants. Responsive to the determination that the forefield has lying plants, the computing device automatically may increase the cutting angle accordingly. Conversely, it may be necessary to decrease the cutting angle and raise the cutting unit to prevent picking up a stand of weeds. Again, in this regard, the computing device is configured to analyze sensor data regarding the forefield in order to identify whether the forefield has a stand of weeds. Responsive to this determination, the computing device automatically may decrease the cutting angle and raise the cutting unit.

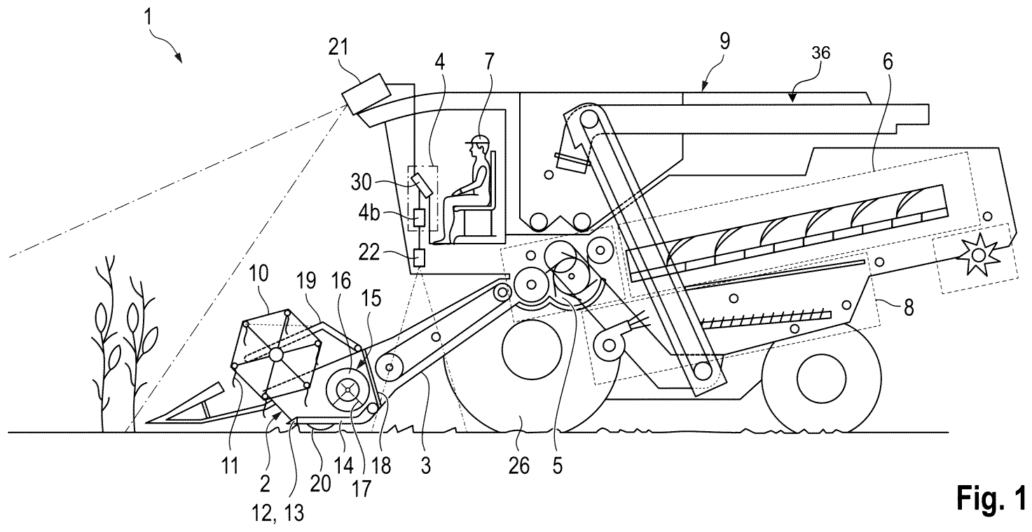

Referring to the figures, FIG. 1 illustrates an agricultural harvesting machine designed as a combine harvester 1, which has a cutting unit 2 designed as an attachment and configured to cut and pick up or collect harvested material. The cutting unit 2 may be exchangeable with another cutting unit 2 so that the combine harvester 1 may be adapted to harvesting different types of crops. In this context, the term harvested material may be understood as all the material picked up from the crop by the cutting unit 2. As may be seen in FIG. 1, a crop is mowed by the cutting unit 2, and the harvested material obtained in this way is fed via an inclined conveyor 3 to a threshing unit 5, a separating stage 6, and a cleaning stage 8 within a body 9 of the combine harvester 1. A transfer pipe 36 for transferring the grain separated from the harvested material to a transport vehicle is shown in a rest position adjacent to the body of the combine harvester.

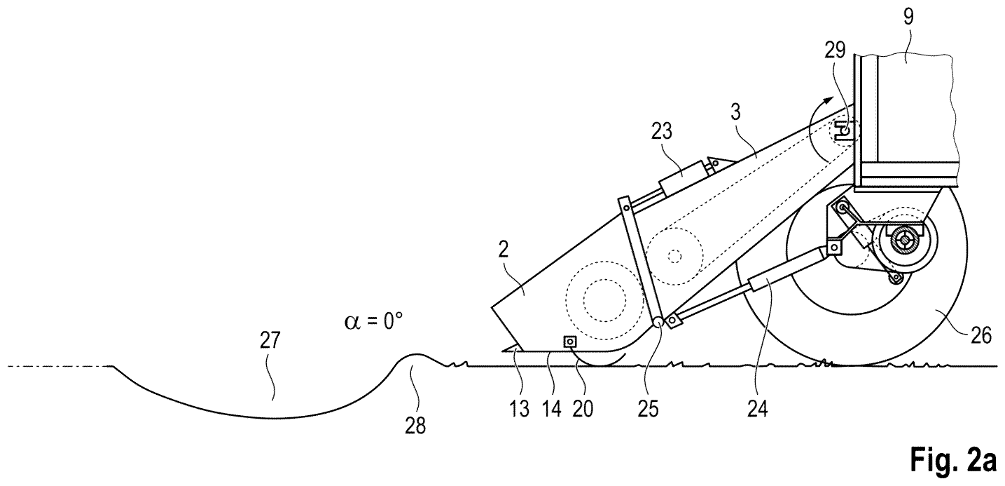

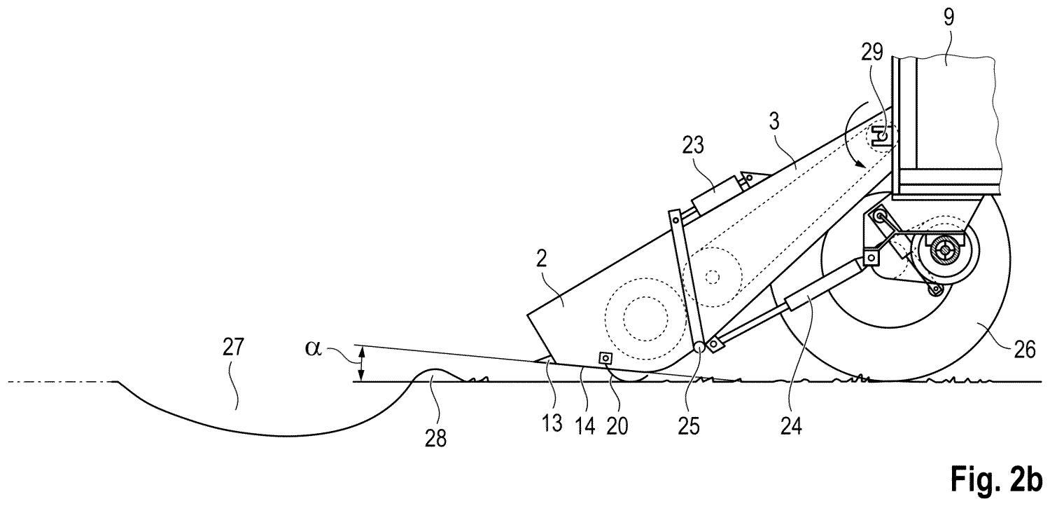

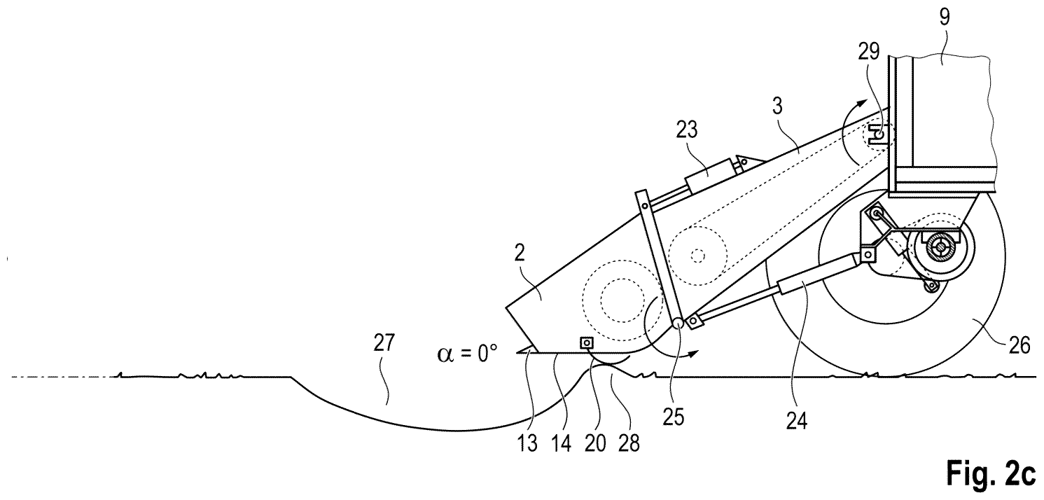

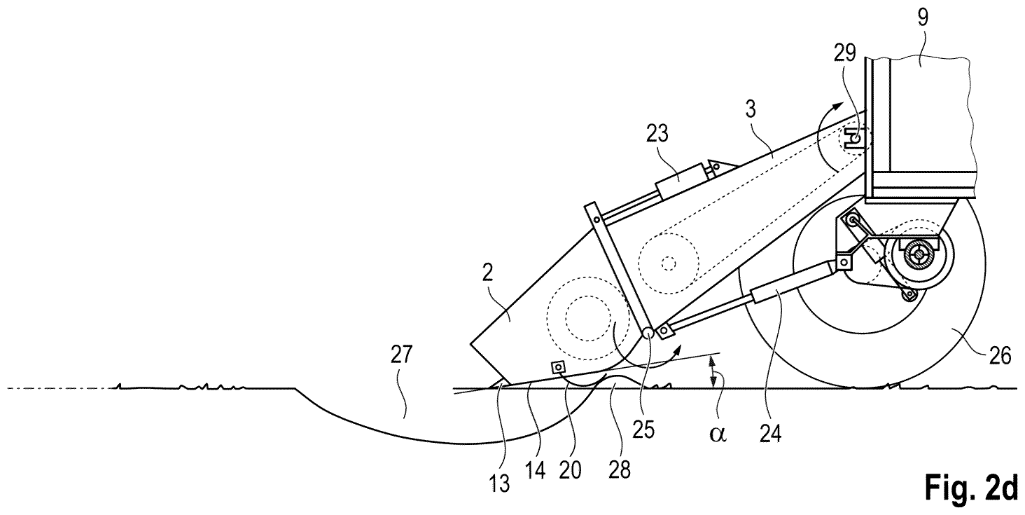

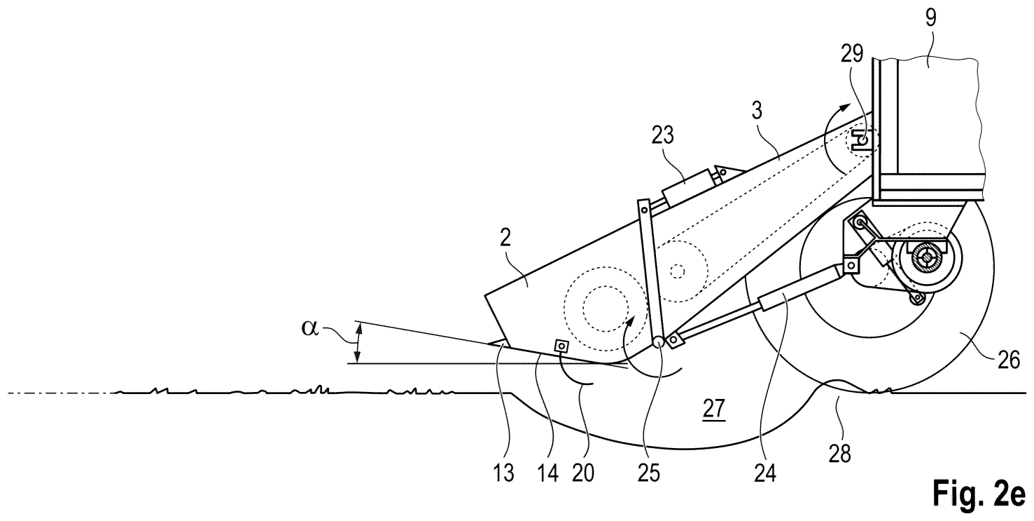

The cutting unit 2 of the depicted combine harvester 1 has a reel 10 running perpendicular to the driving direction of the combine harvester 1 that acts on the still uncut harvested material using tines 11 arranged or positioned thereupon. The reel 10 may primarily have the task of feeding the harvested material to a cutter bar, which may have a movable blade 13 (alternatively termed a knife) and a stationary blade 12 or two cutters that are movable relative to one another. The harvested material is cut in that it enters a space between facing knives of the blades 12/13 over the course of an oscillating movement of the blade 13, and the knives sweep over each other along a cutting plane. The harvested material then falls onto a cutting table 14, the front side of which is formed by the stationary blade 12. The cutting table may extend parallel to the cutting plane of the blades 12/13 or at a small angle thereto so that the orientation of the cutting table 14 in FIGS. 1 and 2 may be regarded as representative of the cutting plane.

Then, the harvested material, potentially with the continued influence of the reel 10, is supplied to the inclined conveyor 3 by an auger 15. In one or some embodiments, the intake auger 15 comprises a central shaft and helical plates 16, which may be attached to the central shaft in two lateral end areas of the intake auger 15, each with an opposite pitch, in order to push, while the intake auger 15 rotates, the cut harvested material from both sides to a central area where it is taken by the inclined conveyor 3. A plurality of intake fingers 17 may be arranged or positioned in the central region of the intake auger 15, which over the course of one revolution of the intake auger extend once from the shaft thereof in order to push harvested material lying on the cutting table 14 backwards to the inclined conveyor 3, and then retract into the shaft again in order to prevent harvested material from being lifted and conveyed over the shaft forwards to the reel 10. A support frame 18 of the cutting unit 2 includes the cutting table 14, a rear wall adjoining the rear edge thereof and having an opening to which the inclined conveyor 3 is connected, as well as side walls that each connect lateral edges of the cutting table 14 and the rear wall and support the intake auger 15. Articulated arms 19, on which the reel 10 is mounted so as to be adjustable in height to adapt to a changing crop height of the harvested material being drawn in by it, are also articulated to these side walls. As discussed in more detail below, the driver assistance system 4 may be configured to automatically control one or more parts of the combine harvester 1, such as the articulated arms 19, in order to automatically control one or more aspects of the cutting unit 2.

To detect unevenness of the ground being driven on, a driver assistance system 4 of the combine harvester 1 is connected to or in communication with one or more sensors. One type of sensor is, for example, a sensing band 20, which may be arranged or positioned on the underside of the cutting table 14 and may be pressed elastically against the ground so that its deflection is representative of the distance between the cutting table 14 and the ground. FIG. 1 further shows sensor 21 for contactless measurement of the ground in front of the combine harvester 1, for example a radar sensor, a laser scanner, a camera or the like. The sensor 21 is shown here on a front roof edge of a driver's cab of the combine harvester 1; alternatively, the sensor 21 may be mounted on a projecting arm of the cutting unit 2, for example on an end of the articulated arms 19 projecting beyond the axis of the reel 10. Another contact-free sensor 22 may be located on the floor of the driver's cab to monitor the ground profile in front of the front wheels 26 of the combine harvester on either side of the inclined conveyor 3.

In order to adjust the cutting unit 2 relative to the ground, two actuators 23, 24 are provided as shown in FIG. 2a-e, which are controllable by the driver assistance system 4 based on data from any one, any combination, or all of sensors 20, 21, 22 according to one or more control strategies as explained below. The actuator 23 has an end fixed to the inclined conveyor 3 and an end engaging an upper edge of the cutting unit 2, and is retractable and extendable to pivot the cutting unit 2 relative to the inclined conveyor 3 about a shaft 25 near a rear edge of the cutting table 14. The second actuator 24 connects a forward end of the inclined conveyor 3 to the body 9 and serves to pivot the inclined conveyor 3 relative to the body 9 about an axis 29.

In FIG. 2a, the ground between the blade 13 and the front wheels 26 is level. Thus, responsive to the driver assistance system detecting (by analyzing sensor data from any one, any combination, or all of sensors 20, 21, 22) that the ground is level, the driver assistance system 4 keeps the cutting table 14 parallel to the ground and, based on distance measurement data from the sensing band 20, a short distance from the ground, wherein the distance may vary depending on the control strategy used.

At the same time, the driver assistance system 4 may be configured to detect an unevenness in the forefield of the combine harvester 1 via the sensor 21 (e.g., a boar's den with a central depression 27 surrounded by an elevation 28 of loose excavated material).

In order to prevent the excavated material from entering the cutting unit 2 when the combine harvester 1 travels further, the cutting unit must be raised. In this regard, responsive to the driver assistance system 4 detecting or identifying on the ground indicative of the excavated material, the driver assistance system 4 may be configured to automatically raise the cutting unit 2. Specifically, raising the entire cutting unit 2 by pivoting the inclined conveyor 3 about the axis 29 requires much power from the actuator 24. As shown in FIG. 2b, with considerably less energy exerted, first only the blade 13 may initially be automatically raised by pivoting the cutting unit about shaft 25 so that the cutting angle α becomes negative. This may already be sufficient to prevent excavated material from being picked up by the cutting unit 2.

According to one control strategy, the driver assistance system 4 may use the information about the elevation 28 ahead to increase the target value for the distance to the ground detected by the sensing band 20. According to an alternative strategy, this information may be disregarded, and in an effort to keep the distance detected by sensing band 20 constant, the driver assistance system 4 first may automatically cause the actuator 24 to lower the inclined conveyor 3 so that, as shown in FIG. 2b, the rear edge of cutting table 14 comes closer to the ground than in FIG. 2a.

To prevent the cutting table 14 from colliding with the elevation 28 as the combine harvester 1 travels further, because the cutting angle α is adjusted to negative, it may be enough to raise the cutting unit 2 much more slowly than if the cutting unit 2 had to be raised by the actuator 24 alone (e.g., the power required for the actuator 24 is much less than if it had to ensure the necessary raising of the cutting unit 2 by itself). By automatically actuating both actuators 23, 24 simultaneously when required, the blade 13 may be raised very quickly.

While the actuator 23 may be controlled in a predictive manner based on the topography of the forefield detected by sensor 21, if the actuator 24 is automatically controlled only based on data from the sensing band 20 as described above, it may not be able to respond to the elevation 28 until it contacts the sensing band 20 under the cutting table 14.

In order to successfully avoid the elevation 28, it may be sufficient for the blade to be higher than the elevation 28 at the moment the blade 13 of the cutting unit 2 reaches the elevation 28; the rear edge of the cutting table 14 may be even lower than the top of the elevation 28, as may be seen in FIG. 2b. It may be sufficient if the rear edge reaches the necessary height only as the cutting table 14 moves over the elevation 28 (e.g., in response to a deflection of the sensing band 20 by the elevation 28).

While the actuator 24 is still lifting the shaft 25 of cutting unit 2 to raise the cutting unit 2 above the elevation 28, the actuator 23 may already begin to pivot the cutting unit 2 about the shaft 25 in the direction of a positive cutting angle α. FIG. 2c shows a condition in which the cutting table 14 is parallel to the ground (i.e., the cutting angle α=0). In this case, the sensing band 20 may have already passed the apex of the elevation 28 and would detect an increasing distance to the ground if it remained in the same position. In the present situation, however, the pivoting movement about the shaft 25 may cause the sensing band 20 to nevertheless detect a decreasing distance to the ground, and the driver assistance system 4 may counteract by automatically raising the inclined conveyor 3.

In FIG. 2d, the rear edge of the cutting table 14 has reached the apex of the elevation; the inclined conveyor 3 has again swung slightly further upward; the cutting unit 2 now has a position with a positive cutting angle α that, if the depression 27 were overgrown with plants, would allow it to cut the plants deeper than if the height of the cutting unit were adjusted only using the actuator 24.

Accordingly, the interaction of both actuators 23, 24, automatically controlled by the driver assistance system 4 based on the topography of the forefield detected by the sensor 21, may allow the height of the blade 13 to follow the ground contour and accordingly minimize harvested material losses.

As soon as the front wheels 26 of the combine harvester 1 reach the depression 27 and begin to dip into it, this may result in a forward pitching motion of the entire combine harvester. To prevent the cutting unit 2 from making contact with the ground in the process, the driver assistance system 4 may estimate the extent of the expected pitching movement based on the profile of the depression known from the data of the sensor 21, and may automatically control the actuators 23, 24 to raise the cutting unit 2 sufficiently to prevent contact with the ground, as shown in FIG. 2e. Here as well, both actuators may work together to raise the blade 13 faster than the rear edge of the cutting table 14, and thereby minimize the risk of damage to the blade.

If the pitching movement takes place while grain is being transferred by means of the transfer pipe 36 to a transport vehicle driving alongside the combine harvester 1, and the transfer pipe 36 follows the pitching movement, this may result in grain missing the accompanying vehicle. To prevent this, provision may be made for the driver assistance system 4 to automatically control a pivoting movement of the transfer pipe 36 opposite the direction of travel, together with the lifting shown in FIG. 2e. By superimposing this backward movement on the forward pitching movement, the point of impact of the grain in the transport vehicle may be kept largely constant, and a loss of grain while transferring may be avoided.

As may be understood from these figures, on the one hand, a positive cutting angle α may be desirable, especially when the position of the actuator 24 is controlled by the sensing band 20, so that the blade 13 may be placed close to the ground and harvested material may be picked up with low loss at a given deflection of the sensing band; on the other hand, it is precisely the small distance from the ground that may require rapid evasive maneuvers in order to avoid contact with the ground, and may result in the need to limit the travel speed of the combine harvester in order to allow the cutting unit to adjust its position in time.

The sensor 21 may also be designed to detect the height of the plant stand. If this is lower than normal in the forefield of the cutting unit 2, it may be an indication of lying plants. While, for example, a standing grain crop may be harvested with a relatively large distance of the blades 12/13 from the ground and a cutting angle α close to 0 since the valuable grains are located at the upper end of the stalk far from the ground, the driver assistance system 4 may automatically increase the cutting angle α when the height of the plant stand is locally low (e.g., lower than a predetermined height) to allow the blades 12/13 to be brought closer to the ground and accordingly also the heads to be picked up close to the ground. In this regard, responsive to the driver assistance system 4 automatically determining that the height of the plant stand is below a predetermined amount, the driver assistance system 4 may automatically increase the cutting angle α (e.g., increase the cutting angle α to a predetermined angle or increasing the cutting angle α by a predetermined number of degrees). In order to be able to react in good time to ground unevenness detected by sensor 21 in this position, it may be necessary for the driver assistance system 4 to also reduce the travel speed of the combine harvester 1 during the transition to the increased cutting angle.

Conversely, if the sensor 21 detects weeds in the plant stand to be harvested, it may be advisable to make the cutting angle α negative and possibly also raise the inclined conveyor 3 so that the weeds pass uncut under the cutting unit 2 and do not contaminate the harvested material. In this regard, in response to the driver assistance system 4 automatically analyzing data from the sensor 21 and automatically detecting, based on the automatic analysis, weeds in the plant stand to be harvested, the driver assistance system 4 may automatically make the cutting angle α negative and/or raise the inclined conveyor 3.

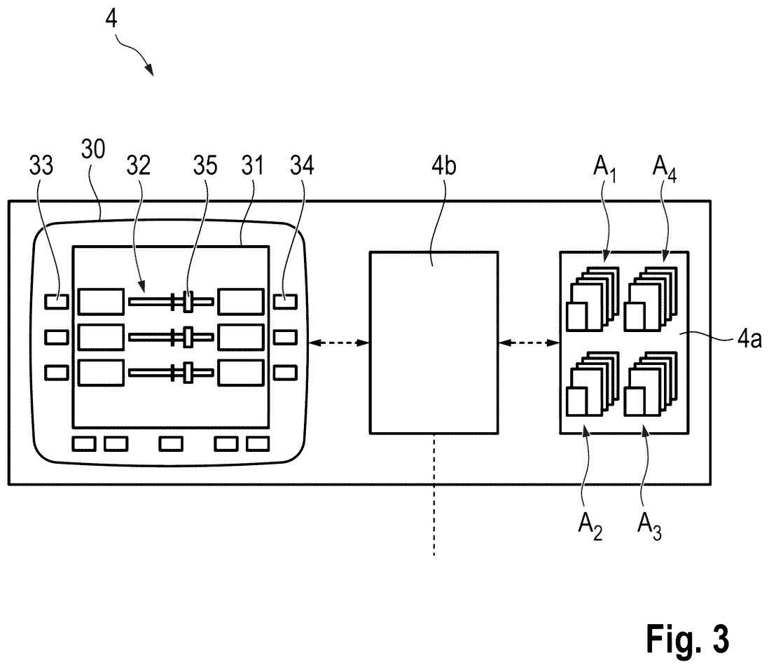

The driver assistance system 4 of the combine harvester 1 shown in FIG. 3 as a block diagram is used at least to automatically control the cutting unit 2, and may also automatically control any one, any combination or all of the threshing unit 5, the separating stage 6; and the cleaning stage 8. In one or some embodiments, the driver assistance system 4 comprises a memory 4a for saving data (e.g., a memory in terms of information technology) and a computing device 4b configured to process the data saved in the memory 4a. In one or some embodiments, the driver assistance system 4 is configured to automatically assist an operator 7 (interchangeable termed driver) of the combine harvester 1 during operation.

The computing device 4b may include at least one processor, with the processor configured to execute the software stored in a memory, such as in memory 4a or in another memory device, which may comprise a non-transitory computer-readable medium that stores instructions that when executed by processor performs any one, any combination, or all of the functions described herein. Thus, the various routines described herein may comprise software routines, which may be executed by computing device 4b. In this regard, the computing device 4b may comprise any type of computing functionality, such as the at least one processor (which may comprise a microprocessor, controller, PLA, or the like) and a memory (such as memory 37 or a separate memory). The memory, such as memory 4a, may comprise any type of storage device (e.g., any type of memory). As shown in FIG. 3, computing device 4b and memory 4a are depicted as separate elements. Alternatively, computing device 4b and memory 4a may be part of a single machine, which includes a microprocessor (or other type of controller) and a memory. Alternatively, computing device 4b may rely on memory 4a for all of its memory needs.

The computing device 4b is merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The actuators 23, 24 may be automatically operated individually or simultaneously by the driver assistance system 4 as above, for example to automatically vary the cutting angle α while maintaining the height of the blades above the ground, or to automatically modify the height above the ground while keeping the cutting angle α constant.

The memory 4a may contain various control strategies for at least the cutting unit 2. The control strategies may also include algorithms for controlling the threshing unit 5 and the cleaning stage 8 appropriate for the nature of the flow of harvested material delivered by the cutting unit 2; however, these will not be described here since they are not directly related to the invention.

Each control strategy may include an algorithm for the driver assistance system 4 to automatically adjusting the height and cutting angle of the cutting unit 2 depending on the measurement results of the sensors 20, 21. The algorithms may vary depending on how the combine harvester is equipped with sensors (e.g., in general, an algorithm that relies solely on measured values of the sensing band 20 to prevent ground contact of the cutting unit 2 may, on average, adjust a different height of the blades 12/13 above the ground to achieve predetermined safety from ground contact than an algorithm that additionally has measured values of the ground profile in front of the cutting unit 2 from the sensor 21 and that may trigger a sufficiently fast lifting of the cutting unit when a ground elevation in front of the cutting unit 2 is detected). An algorithm, executed by the driver assistance system 4, that is based on data from the sensor 21 may automatically control the position of the cutting unit 2 differently depending on whether the soil surface detected by sensor 21 is actually that of the soil, or is possibly that of a layer of mulch or residue of a previous culture lying on top of it, which may in no way be picked up by cutting unit 2 and fed to the threshing unit. Thus, the driver assistance system 4 may analyze the sensor data in order to make the determination as to whether the soil surface detected by sensor 21 is soil or is a layer of mulch or residue of a previous culture lying on top of it, and automatically control the cutting unit 2 accordingly.

Furthermore, the sensor 21 may also be configured to automatically detect an average height above the ground of fruit of the harvested material in a spatially resolved manner so that the driver assistance system 4 may automatically use this data to automatically lower the height of the cutting unit if necessary, for example to pick up the heads even of lying grain.

Even if one assumes that an algorithm would be able to create an error-free profile of the soil surface on the basis of the data from the sensors 20, 21, the problem remains that a locally different sinking of individual wheels of the combine harvester into the soil, whether due to unevenness that has not been taken into account or to yielding of the soil due to moisture or underground animal burrows, may lead to unpredictable changes in the distance between the cutting unit 2 and the soil and in the cutting angle. In order to take this problem into account, at least two algorithms A₁, A₂ are provided according to one aspect of the invention, of which algorithm A₁ is optimized to collect as much harvested material as possible but, at the expense of the ground clearance of cutting unit 2, may tend to adjust a high cutting angle or, in order to pick up low-lying harvested material, may accept a height of the cutting unit above the ground which may lead to ground contact in the event of sinking, whereas algorithm A₂ is optimized to avoid ground contact, but losses of harvested material must be accepted if necessary.

According to FIG. 3, the computing device 4b may automatically control a user interface 30 in the driver's cab to display an image with at least one slider 32 on a screen 31. Keys 33, 34 (interchangeably termed buttons) assigned to the slider 32 beyond the edge of the screen 31 may be used on the one hand, provided that more than the algorithms A₁, A₂ are available for selection, to assign an algorithm to each stop position of the slider, according to which the driver assistance system 4 automatically controls the cutting unit 2, such as the height of the blades 12/13 and/or the cutting angle α if a control knob 35 of the slider is at a particular stop position adjacent to this key 33, 34. Once this assignment has been made, the same keys 33, 34 may be used to shift the position of the control knob 35 stepwise in the direction of the tapped key by tapping it once or several times, and accordingly define a weighting factor c with which the algorithms A₁, A₂ assigned to the keys 33, 34 influence the control of the cutting unit 2. In this regard, the driver assistance system 4 may receive input from the operator 7 and device various parameters, such as the weighting factor c. Alternatively, the slider may be provided as a physical component, or the screen 31 may comprise a touchscreen that is touch-sensitive so that the operator 7 may move the displayed control knob 35 by directly touching it and dragging it back and forth with a finger movement.

In view of the arable land to be worked, the operator 7 may assess the extent to which the land meets the requirements for use of the algorithm A₁ or A₂, if necessary also with recourse to experience gained during previous working of the same land or over the course of currently working this land, and accordingly adjust the slider 32 before starting to work the land, or also while working.

When the target cutting angle of the blades 12/13 established by algorithm A₁ based on current measured values of sensors 20, 21, 22 is α₁ and the target cutting angle established by algorithm A₂ is α₂, the driver assistance system 4 may establish or determine a weighted average value as the target cutting angle of the cutter bar a in which each target cutting angle αᵢ, i=1, 2 is weighted more the closer the control knob 35 is to the end of the slider 32 assigned to the algorithm Aᵢ. In particular, if the distance of the control knob 35 from the end of the slider 32 associated with algorithm A₁ is a fraction c of its length and the distance from the end associated with algorithm A₂ is 1−c, α₁ may be weighted with 1−c, and α₂ may be weighted with c. This is merely one example of the operator 7 providing input for the driver assistance system 4 to determine the weighting factor c. Other manners and means are contemplated.

If, while working the land, the driver finds that the yielding is different than expected, she/he may continuously adapt the control of the cutting unit 2 thereto, for example by tapping the key 33 to change the algorithm A₁, or by tapping the key 33 to change the weighting factor c.

It is also contemplated that both algorithms A₁, A₂ use a uniform calculation rule to calculate a preliminary cutting angle, but limit this by different upper limits αₘₐₓ₁, αₘₐₓ₂ in order to establish the target cutting angle α actually used to control the cutting unit 2, and the position of the control knob 35 determines an interpolated upper limit αₘₐₓ* by means of a calculation rule as a function of the first and second upper limits αₘₐₓ₁, αₘₐₓ₂, wherein the weighting variable c determines the influence of the first and second extreme values αₘₐₓ₁, αₘₐₓ₂ on the result of the calculation rule. As described above, the calculation rule may be a weighted averaging. While in the previously described case, the target cutting angle α is calculated by interpolating the angles α₁ and α₂ obtained by the algorithms A₁, A₂ and, providing that they are different, each change of the weighting factor c causes a change of the target intersection angle α, in this case a change of the weighting factor c does not influence the target cutting angle α* as long as it is below a current interpolated upper limit αₘₐₓ before and after the change.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Combine harvester
2 Cutting unit
3 Inclined conveyor
4 Driver assistance system
5 Threshing unit
6 Separating stage
7 Driver
8 Cleaning stage
9 Body
10 Reel
11 Tines
12 Blade
13 Blade
14 Cutting table
15 Intake auger
16 Plate
17 Intake finger
18 Support frame
19 Articulated arm
20 Sensing band
21 Sensor
22 Sensor
23 Actuator
24 Actuator
25 Axle
26 Front wheel
27 Depression
28 Elevation
29 Axle
30 User interface
31 Screen
32 Slider
33 Key
34 Key
35 Control knob
36 Transfer pipe

1. An agricultural harvesting machine comprising:
a cutting unit configured to cut harvested material; and
a driver assistance system comprising at least one processor and at least one memory, the at least one memory configured to store a first control strategy and a second control strategy for operation of the cutting unit;
wherein the at least one processor is configured to:
link the first control strategy and the second control strategy to one another via a weighting variable;
receive input from a driver of the agricultural harvesting machine in order to adjust the weighting variable;
determine, based on at least one of the first control strategy or the second control strategy and on forefield information, a cutting angle; and
control the cutting unit based on the cutting angle.

2. The agricultural harvesting machine of claim 1, wherein the at least one processor is configured to determine the linking of the first control strategy and one second control strategy by:
determining a first value of the cutting angle based on the first control strategy;
determining a second value of the cutting angle based on the second control strategy; and
determining a target cutting angle for the cutting unit using a calculation rule that is a function of the first value of the cutting angle, the second value of the cutting angle, and the weighting variable to weight the first value of the cutting angle and the second value of the cutting angle in order to determine the target cutting angle; and
wherein the at least one processor is configured to control the cutting angle of the cutting unit based on the target cutting angle.

3. The agricultural harvesting machine of claim 2, wherein the first value of the cutting angle is smaller than the second value of the cutting angle.

4. The agricultural harvesting machine of claim 1, wherein the at least one processor is configured to determine the linking of the first control strategy and the second control strategy by:
determining a first extreme value of the cutting angle permissible for being set in the cutting unit based on the first control strategy;
determining a second extreme value of the cutting angle permissible for being set in the cutting unit based on the second control strategy;
determining a limit for a target cutting angle for the cutting unit using a calculation rule that is a function of the first extreme value of the cutting angle, the second extreme value of the cutting angle, and the weighting variable to weight the first extreme value of the cutting angle and the second extreme value of the cutting angle in order to determine the limit of the target cutting angle; and
determining a limit for a target cutting angle for the cutting unit using a calculation rule that is a function of the first extreme value of the cutting angle, the second extreme value of the cutting angle, and the weighting variable; and
wherein the at least one processor is configured to limit the cutting angle of the cutting unit based on the limit of the target cutting angle.

5. The agricultural harvesting machine of claim 4, wherein the first extreme value of the cutting angle is smaller than the second extreme value of the cutting angle.

6. The agricultural harvesting machine of claim 1, wherein the first control strategy is optimized with regard to one or both of avoiding damage to the cutting unit or to ground by contact of the cutting unit to the ground; or
wherein the second control strategy is optimized with regard to minimizing harvested material losses.

7. The agricultural harvesting machine of claim 1, wherein the first control strategy is optimized with regard to one or both of avoiding damage to the cutting unit or to ground by contact of the cutting unit to the ground; and
wherein the second control strategy is optimized with regard to minimizing harvested material losses.

8. The agricultural harvesting machine of claim 1, further comprising a user interface comprising a user input device configured to receive input from a user indicative of the weighting variable.

9. The agricultural harvesting machine of claim 1, further comprising a sensor configured to perform one or both of detecting or updating the forefield information in real time; and
wherein the at least one processor is configured to determine the cutting angle based on the forefield information that is detected or updated in real time.

10. The agricultural harvesting machine of claim 9, wherein the forefield information comprises topographical information describing a forefield in front of the cutting unit of the agricultural harvesting machine.

11. The agricultural harvesting machine of claim 10, wherein the at least one processor is configured to:
predict, based on the topographic information, whether there is a forward pitching movement of the agricultural harvesting machine; and
responsive to predicting that there is the forward pitching movement of the agricultural harvesting machine, use at least one of the first control strategy and the second control strategy to reduce the cutting angle.

12. The agricultural harvesting machine of claim 10, further comprising a transfer chute; and
wherein the at least one processor is configured to:
predict, based on the topographic information, a pitching movement of the agricultural harvesting machine; and
responsive to predicting the pitching movement of the agricultural harvesting machine, correct a position of the transfer chute to at least partly counteract the pitching movement.

13. The agricultural harvesting machine of claim 10, wherein the topographic information comprise information on a plant stand in the forefield; and
wherein the at least one processor is configured to control the cutting angle of the cutting unit at least partly based on the information on the plant stand in the forefield.

14. The agricultural harvesting machine of claim 13, wherein the information on the plant stand in the forefield comprises one or both of density or height of the plant stand; and
wherein the at least one processor is configured to control the cutting angle of the cutting unit at least partly based on the one or both of density or height of the plant stand.

15. The agricultural harvesting machine of claim 13, wherein the at least one processor is configured to:
determine whether the forefield information indicates a height of the plant stand below a predetermined amount; and
responsive to determining that the forefield information indicates the height of the plant stand below a predetermined amount, use at least one of the first control strategy and the second control strategy to increase the cutting angle.

16. The agricultural harvesting machine of claim 15, wherein the at least one processor is configured to:
determine whether the forefield information indicates lying plants; and
responsive to determining that the forefield information indicates the lying plants, use at least one of the first control strategy and the second control strategy to increase the cutting angle.

17. The agricultural harvesting machine of claim 1, wherein the at least one processor is configured to:
determine whether the forefield information indicates a convex curvature or a concave curvature of ground;
responsive to determining that the forefield information indicates the convex curvature of the ground, use at least one of the first control strategy and the second control strategy to increase the cutting angle; and
responsive to determining that the forefield information indicates the concave curvature of the ground, use the at least one of the first control strategy and the second control strategy to decrease the cutting angle.

18. The agricultural harvesting machine of claim 1, wherein the at least one processor is configured to:
determine whether there is a downward movement of the cutting unit or an upward movement of the cutting unit;
responsive to determining there is the downward movement of the cutting unit, use at least one of the first control strategy and the second control strategy to adjust the cutting angle to higher than when height of the cutting unit remains constant; and
responsive to determining there is the upward movement of the cutting unit, use at least one of the first control strategy and the second control strategy to adjust the cutting angle to lower than when the height of the cutting unit remains constant.
